(19) United States
(12) Patent Application Publication
(10) Pub. No.: US 2024/0272791 A1
(43) Pub. Date: Aug. 15, 2024

(54) Automatic Data Layout for Operation Chains

(71) Applicant: Advanced Micro Devices, Inc., Santa Clara, CA (US)

(72) Inventors: Benjamin Youngjae Cho, Austin, TX (US); Armand Bahram Behroozi, Ann Arbor, MI (US); Michael L. Chu, San Jose, CA (US); Emily Anne Furst, Duvall, WA (US)

(73) Assignee: Advanced Micro Devices, Inc., Santa Clara, CA (US)

(21) Appl. No.: 18/108,653

(22) Filed: Feb. 12, 2023

(51) Int. Cl. G06F 3/06

(52) U.S. Cl. CPC G06F 3/0604; G06F 3/0629; G06F 3/0671; G06F 9/4881; G06F 9/5016; G06F 9/5066

(57) ABSTRACT

Automatic generation of data layout instructions for locating data objects in memory that are involved in a sequence of operations for a computational task is described. In accordance with the described techniques, an interference graph is generated for the sequence of operations, where individual nodes in the interference graph represent data objects involved in the computational task. The interference graph includes edges connecting different pairs of nodes, such that an edge indicates the connected data objects are involved in a common operation of the sequence of operations. Weights are assigned to edges based on architectural characteristics of a system performing the computational task as well as a size of the data objects connected by an edge. Individual data objects are then assigned to locations in memory based on edge weights of edges connected to a node representing the data object, optimizing system performance during the computational task.

### BACKGROUND

Uniform memory access is a type of computer architecture that enables different processors to equally use memory locations for storage and processing of data. In contrast to uniform memory access, some computer architectures are designed with non-uniform memory access, such as processing-in-memory (PIM) architectures, processing-near-memory (PNM) architectures, multi-chip module processors, and so forth. PIM architectures, for instance, move processing of memory-computations to memory. This contrasts with conventional computer architectures that communicate data back and forth between a memory and a remote processing unit. In terms of data communication pathways, remote processing units of conventional computer architectures are further away from memory than processing-in-memory components. As a result, these conventional computer architectures suffer from increased data transfer latency, which can decrease overall computer performance.

Further, due to the proximity to memory, PIM architectures can also provision higher memory bandwidth and reduced memory access energy relative to conventional computer architectures particularly when the volume of data transferred between the memory and the remote processing unit is large. PIM components, however, are limited with respect to the data that can be accessed from memory. For instance, a PIM component implemented in a memory channel often cannot access data stored outside the memory channel. Thus, realizing advantages of PIM, PNM, multi-chip module, and other non-uniform memory access architectures when performing a computational task is often dependent on a layout of data processed in performing the computational task.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a block diagram of an example system having a processor with at least one core, a memory module with a memory and a processing-in-memory component.

FIG. 2 depicts an example of generating an interference graph for a computational task.

FIG. 3 depicts an example of a sequence of operations performed as part of a computational task and an unweighted interference graph generated from the sequence of operations.

FIG. 4 depicts an example of an interference graph for a computational task.

FIG. 5 depicts an example of generating data layout instructions for a computational task using a weighted interference graph for the computational task.

FIG. 6 depicts a procedure in an example implementation of generating an interference graph for a computational task.

FIG. 7 depicts a procedure in an example implementation of allocating data in memory for a computational task and scheduling a sequence of operations for the computational task using the allocated data in memory.

### DETAILED DESCRIPTION

### Overview

In contrast to conventional uniform memory access architectures, some computer architectures have non-uniform memory access architectures, such as processing-in-memory (PIM) architectures, processing-near-memory (PNM) architectures, multi-chip module processors, and so forth. Non-uniform memory access enables multiple processors to access shared memory, where memory access time depends on a memory location relative to a processor accessing data stored in the memory location. In a non-uniform memory access architecture, a processor accesses data stored in its own local memory faster than data stored in non-local memory.

In one example of non-uniform memory access, computer architectures with PIM components implement processing devices embedded in memory hardware (e.g., memory chips). By implementing PIM components in memory hardware, PIM architectures are configured to provide memory-level processing capabilities to a variety of applications, such as applications executing on a processing device that is communicatively coupled to the memory hardware. In such implementations where the PIM component provides memory-level processing for a computational task (e.g., processing for an application executed by the processing device), the processing device controls the PIM component by dispatching a sequence of operations (e.g., a sequence of application operations) for performance by the PIM component.

In implementations, a PIM component is configured to execute operations (e.g., a chain of related PIM operations) using data stored in one or more banks of a memory device (e.g., a dynamic random-access memory (DRAM) device). DRAM devices employ row buffers (at least one per bank) in which memory reads and writes take place. Accesses to a DRAM row that is different from the one in the row buffer requires closing the currently buffered or open row and activating the requested row, which is referred to as a row-buffer conflict and incurs performance and energy penalties. DRAM row-buffer conflicts limit an optimal exploitation of available system memory bandwidth and increase the memory-access latencies due to closing and activating DRAM rows.

One approach for avoiding row-buffer conflicts is accessing as many data elements as possible from a common row. However, there is no guarantee that adjacent data elements which fall into the same operating system page or contiguous physical address space will be accessed together. The placement of data elements inside physical memory locations (e.g., a particular DRAM channel, bank, row, column, etc.) depends on the physical address to physical memory mapping schemes employed by a memory controller that controls access to the DRAM. Further, unlike processors such as central processing units (CPUs) and parallel processors such as graphics processing units (GPUs) that can access multiple channels of a DRAM device, a PIM component is limited to accessing banks to which it is local and is therefore unable to exploit high bank-level parallelism to achieve high memory bandwidth.

While storing as many data elements as possible within a common bank is helpful in achieving high PIM performance, such data co-location results in low bank-level parallelism. For example, when computing a[i]=b[i]+c[i], where i represents a bank in memory, while each of the operands a, b, and c are located in a common bank and thus have data co-location, they require serialized access to the same bank and suffer from row-buffer conflicts that incur extra latency to close and open rows. Accordingly, the impact of row-buffer conflicts on PIM performance can be significant, as the row-switching overhead cannot be hidden by accessing multiple banks in parallel. These system performance impacts are further compounded when considered over execution of a chain of PIM operations.

Given these limitations associated with non-uniform memory access architectures, such as PIM architectures, it is important to organize data for a given computational task (e.g., application, process, algorithm, etc.). For instance, all operands for a given computational task must be located in local memory for the processing component that executes the given computational task (e.g., within the DRAM channel for the PIM component).

Conventional approaches to organizing data involved in execution of a computational task by a processing device in a non-uniform memory architecture involve manually designing a data layout for the particular computational task. For instance, in conventional approaches a human user authors code that instructs a processing device to store data involved in a sequence of operations at specific locations in memory. In such conventional approaches, the human user identifies operands that are frequently used when performing a computational task and assigns memory locations for storing these frequently used operands during execution of the computational task in a manner that enables convenient data access so that the computational task can be performed efficiently.

This conventional approach of manually organizing a layout for data involved in a given computational task, however, involve significant human intervention, which is tedious, cumbersome, and prone to user error. Furthermore, this conventional approach of manually organizing a layout for data involved in a given computational task is not extendable or scalable to different computational tasks. As yet another drawback, this conventional approach often is unable to handle scenarios where a computational task involves a sequence of operations and a result generated by one operation is involved in a subsequent one of the sequence of operations. For instance, the conventional approach of manually organizing data layouts fail to handle a sequence of operations where one operation involves A+B=C and a subsequent operation involves C+D=E.

To handle operation chains where the output of one operation is used as an input to a subsequent operation in the chain, some conventional approaches perform data copying. In a data copying approach, data generated as a result of a first operation that is subsequently involved in a second operation is stored at a first memory location as part of executing the first operation. When it becomes time to execute the second operation, the data generated from the first operation is copied from the first memory location to a second storage location that is conveniently accessible during performance of the second operation. However, this approach of data copying is computationally expensive and introduces undue delay into executing the chain of operations by wasting time copying data from one memory storage location to another, thus resulting in degraded overall system performance.

To address these problems facing data layout for computational tasks performed using non-uniform memory access architectures, automatic data layout for operation chains is described. In implementations, an optimal layout of data involved in performing a sequence of operations for a computational task (e.g., as part of executing a computer application) is identified automatically and independent of (e.g., without) user input or intervention. Defining that all data generated by, or otherwise involved in, a sequence of operations be maintained in local memory for a non-uniform memory access architecture processor (e.g., a PIM component) ensures that the processor will be able to perform the sequence of operations.

However, simply defining that data associated with the sequence of operations be stored in local memory does not guarantee that the processor will be able to perform the sequence of operations efficiently, or in a manner that reduces computational latency while optimizing consumption of computational resources. Accordingly, the techniques described herein perform automatic data layout for operation chains in a manner that ensures efficient performance of operations in a sequence of operations, minimizing processing time and computational resources required to do so.

In implementations, a system configured with a non-uniform memory access architecture includes a processing component configured to execute a sequence of operations. In the following discussion, the processing component is described with respect to example implementations as being configured as a PIM component. For instance, in implementations a system includes a memory module having a memory and a PIM component. The memory module is communicatively coupled to at least one core of at least one processor. The system further includes an operation scheduler, such as an operation scheduler implemented locally at a processor, an operation scheduler implemented at the memory module, or an operation scheduler implemented separate from a processor and separate from the memory module. In implementations, the processor implements a data layout system that is configured to generate data layout instructions for a sequence of operations (e.g., an operation chain) to be executed by the PIM component as part of performing a computational task. Alternatively, in some implementations the data layout system is implemented at the operation scheduler.

The operation scheduler implements a graph adaptation system that is configured to update the data layout instructions generated by the data layout system, at runtime for the computational task, based on current conditions of the memory module. In implementations, the data layout system and the graph adaptation system are configured to determine an address interleaving pattern for data storage in memory of the memory module in a manner that maximizes bank-level parallelism of data involved in the sequence of operations performed by the PIM component. For instance, the data layout system and the graph adaptation system are configured to follow an address interleaving pattern by performing address hashing using at least a portion of a row identifier for a row in memory to determine channel identifiers and bank identifiers for a storage location in the memory, such as the address hashing techniques described in U.S. patent application Ser. No. 17/956,955, filed Sep. 30, 2022, the disclosure of which is hereby incorporated by reference in its entirety.

In implementations, the data layout system and the graph adaptation system follow a PIM interleaving pattern that co-locates input and output operands for PIM operations in the same PIM-local memory location(s) while exploiting row-buffer locality and complying with conventional memory abstraction. In implementations, such a PIM interleaving pattern allocates memory according to “super rows,” where a super row represents a virtual row that spans all banks of a memory device. Each super row has a different bank-interleaving pattern, referred to herein as a “color.” A group of super rows that has the same PIM-interleaving pattern is referred to herein as a “color group.” In this manner, the address interleaving pattern followed by the data layout system and the graph adaptation system assigns memory addresses to the elements of each operand of a PIM operation to a super row having a different color within the same color group. The address interleaving pattern thus co-locates operand elements for PIM operation chains and uses address hashing to alternate between banks assigned to elements of a first operand and elements of a second operand of a given PIM operation.

In these color group implementations, the data layout system and the graph adaptation system generate data layout instructions by mapping data objects involved in a sequence of operations to a common color group. By mapping different data objects involved in a sequence of operations to a common color group, the data layout instructions are generated in a manner that simultaneously satisfies PIM locality considerations and row-buffer locality considerations. Mapping data objects to a common color group satisfies PIM locality considerations, but not necessarily row-buffer locality considerations. Thus, to satisfy row-buffer locality considerations, the data layout instructions are generated to assign different colors of a same color group to the data objects associated with a same PIM operation.

As described herein, PIM locality considerations refer to co-alignment of data objects such that data objects and same-index elements in memory local to (e.g., accessible by) a PIM component. As described herein, row-buffer locality considerations refer to enablement of accessing as many data elements as possible once a row is stored in a row buffer. For instance, if the color red is allocated to data object A and the color blue is allocated to data object B, where the operation is B[i]=A[i] and red and blue belongs to the same color group, A[i] and B[i] will always located in different banks within memory local to a PIM component.

Under the address interleaving patterns implemented by the data layout system and the graph adaptation system, the techniques described herein seek to store data objects that are involved in a same one of the sequence of operations (e.g., same-index data elements) in different banks of memory, thereby maximizing bank-level parallelism during performance of the sequence of operations. In implementations, the address interleaving pattern leveraged by the data layout system and the graph adaptation system is uniform across each super row of the memory, where a super row is representative of a virtual row that spans all banks of the memory. In implementations, super rows are represented using colors, such that each super row is assigned a color, where an address interleaving pattern associated with one color may be different from an address interleaving pattern associated with a different color.

In accordance with the techniques described herein, the data layout system and the graph adaptation system are configured to generate data layout instructions that map data objects involved in a sequence of operations among super rows of memory. In this manner, the data layout instructions store data objects associated with a given operation are in different banks of a portion of the memory that is local to the PIM component executing the sequence of operations. In implementations where it is not possible to map different data objects involved in a given operation to different banks, the data layout system and the graph adaptation system are configured to generate data layout instructions in a manner that minimizes computational cost during performance of the sequence of operations.

For instance, it is computationally expensive to switch between different rows of a bank when executing operations using a PIM component. Conversely, it is less computationally expensive if data is stored in different banks, as a PIM component is not required to precharge (e.g., close) an open row and activate (e.g., open) a different row to access data objects. Row precharging and row activation each require time to perform, thus generating data layout instructions in a manner that mitigates row precharging and activation wherever possible reduces delay and computational resources required to perform a sequence of operations.

In automatically generating the data layout instructions for a sequence of operations executed as part of performing a computational task, the data layout system is configured to construct an interference graph that represents each data object involved in the sequence of operations as a graph node. The data layout system then establishes edges between various pairs of the graph nodes, where an edge is generated between different data objects if the different data objects are involved in a common one of the sequence of operations. The data layout system then assigns weights to each of the edges in the interference graph, where an edge weight represents the costs of mapping data objects represented by the connected nodes into a same bank in memory. In implementations, an edge weights is a numerical value that represents how many memory bank conflicts will occur if the data objects connected by the edge are placed into the same bank (e.g., a high edge weight indicates a high computational cost will be incurred if the connected data objects are located in a common memory bank).

In computing edge weights of the interference graph for a computational task, the data layout system considers a relative size of one or more registers of the processing component executing the computational task (e.g., a register size of a PIM component) to a size of a row in a bank of memory that stores data involved in executing the computational task. The edge weights are further computed based on a number of different rows that the two different data objects connected by an edge span (e.g., a number of memory rows required to store the size of data objects linked by an edge).

After building an interference graph and computing an edge weight for each edge in the interference graph, the data layout system assigns data objects represented in the interference graph to storage locations in memory. In implementations, the data layout system assigns data objects to storage locations by assigning adjacent vertices to different super rows of a common color group whenever possible. In this manner, the data layout instructions assigns different data objects involved in a common operation to different rows in memory, thus minimizing a computational cost associated with executing the operation.

In situations where system architecture precludes assigning all data objects involved in a common operation to different rows of a common color group, the data layout instructions are generated with a minimum cut constraint. The minimum cut constraint biases the data layout system and the graph adaptation system to assign storage locations to data objects in a manner that favors assigning data objects connected by a lower weighted edge to a common memory row over data objects connected by a higher weighted edge. The minimum cut constraint thus encourages generation of data layout instructions, for a computational tasks involving a sequence of operations, that minimizes an overall cost of executing the sequence of operations. The data layout system is configured to generate the data layout instructions for a computational task at compile time for the computational task based on the system architecture of a processing component and memory used to execute the computational task. After compile and before runtime of the computational task, the data layout system communicates the data layout instructions to the graph adaptation system.

The graph adaptation system is configured to adapt the data layout instructions based on a condition of the memory and the processing component used to execute the computational task, at runtime for the computational task. For instance, the graph adaptation system is configured to determine whether memory locations indicated in the data layout instructions received from the data layout system are available at runtime. If the memory locations indicated in the data layout instructions received from the data layout system are available at runtime, the graph adaptation system passes the data layout instructions, unaltered, to a memory allocator for use in allocating memory at runtime. Alternatively, if the memory locations indicated in the data layout instructions received from the data layout system are unavailable at runtime, the graph adaptation system generates an adapted interference graph based on available data storage locations in memory and communicates data layout instructions with the adapted interference graph to the memory allocator for use in allocating memory at runtime. In some implementations, the graph adaptation system is implemented as part of a system memory allocator. Alternatively, in some implementations the graph adaptation system is implemented separately from a system memory allocator.

Thus, using the techniques described herein, the data layout system is configured to generate data layout instructions that optimize execution of a sequence of operations involved in a computational task based on an architecture of a system that performs the computational task. The graph adaptation system is further configured to adapt the data layout instructions at runtime of the computational task based on system conditions (e.g., a current and/or scheduled system load), thus ensuring end-to-end optimization of the computational task automatically and independent of user input, which is not possible using conventional data layout approaches.

Although described with respect to a single PIM component, the techniques described herein are configured for implementation by multiple processing-in-memory components in parallel (e.g., simultaneously). For instance, in an example scenario where memory is configured as DRAM, a processing-in-memory component is included at each hierarchical DRAM component (e.g., channel, bank, array, and so forth) and the data layout instructions include respective interference graphs for each PIM component.

In some aspects, the techniques described herein relate to a system including a memory module including a memory and a processing-in-memory circuit, a processor including at least one core configured to generate an interference graph for a computational task that assigns data objects involved in the computational task to respective locations in the memory, and an operation scheduler configured to allocate the data objects to the respective locations in the memory and schedule the computational task for execution by the processing-in-memory circuit.

In some aspects, the techniques described herein relate to a system, wherein the processor is configured to generate the interference graph automatically and independent of user input.

In some aspects, the techniques described herein relate to a system, wherein the processor is configured to generate the interference graph based on a number of banks in a channel of the memory that is accessible by the processing-in-memory circuit.

In some aspects, the techniques described herein relate to a system, wherein the processor is configured to generate the interference graph by representing each of the data objects involved in the computational task as a node in the interference graph.

In some aspects, the techniques described herein relate to a system, wherein the processor is configured to generate the interference graph by establishing an edge between a pair of nodes in the interference graph that represent two data objects involved in a common operation of the computational task.

In some aspects, the techniques described herein relate to a system, wherein the processor is configured to generate the interference graph by assigning a weight to the edge, wherein the weight is a value representing a computational cost incurred by allocating the two data objects to a common bank in the memory.

In some aspects, the techniques described herein relate to a system, wherein the processor is configured to compute the weight for the edge based on a relative size of a register of the processing-in-memory circuit to a size of a row in a bank of the memory.

In some aspects, the techniques described herein relate to a system, wherein the processor is configured to compute the weight for the edge based on a size of the two data objects.

In some aspects, the techniques described herein relate to a system, wherein the processor is configured to generate the interference graph by assigning one of the data objects involved in the computational task to one of the respective locations in the memory based on weights of one or more edges connected to a node representing the one of the data objects in the interference graph.

In some aspects, the techniques described herein relate to a system, wherein the processor is configured to generate the interference graph with an objective of allocating data objects involved in a common operation for the computational task to different banks in the memory.

In some aspects, the techniques described herein relate to a system, wherein the operation scheduler is configured to allocate the data objects to the respective locations in the memory and schedule the computational task for execution by the processing-in-memory circuit in response to identifying that the memory is available to allocate the data objects as indicated by the interference graph at runtime for the computational task.

In some aspects, the techniques described herein relate to a method including receiving an operation chain that includes a plurality of operations for execution by a processing-in-memory circuit, generating an interference graph that assigns data objects involved in the operation chain to respective locations in a memory, and allocating the data objects involved in the operation chain to the respective locations in the memory.

In some aspects, the techniques described herein relate to a method, wherein generating the interference graph and allocating the data objects are performed prior to the processing-in-memory circuit executing the operation chain.

In some aspects, the techniques described herein relate to a method, wherein generating the interference graph is performed automatically and independent of user input.

In some aspects, the techniques described herein relate to a method, wherein generating the interference graph is performed based on a number of banks in a channel of the memory that is accessible by the processing-in-memory circuit.

In some aspects, the techniques described herein relate to a method, wherein generating the interference graph includes representing each of the data objects involved in the operation chain as a node in the interference graph.

In some aspects, the techniques described herein relate to a method, wherein generating the interference graph includes establishing an edge between a pair of nodes in the interference graph that represent two of the data objects involved in a common operation of the operation chain.

In some aspects, the techniques described herein relate to a method including receiving an interference graph for a computational task that assigns data objects involved in the computational task to respective locations in a memory, identifying that one or more of the respective locations in the memory allocated by the interference graph are unavailable, generating an adapted interference graph that assigns the data objects involved in the computational task to available locations in the memory, responsive to identifying that the one or more of the respective locations in the memory allocated by the interference graph are unavailable, and allocating the memory for the computational task using the adapted interference graph.

In some aspects, the techniques described herein relate to a method, wherein the interference graph is generated at compile time for the computational task and generating the adapted interference graph is performed at runtime for the computational task.

In some aspects, the techniques described herein relate to a method, wherein the interference graph assigns the data objects involved in the computational task to the respective locations in the memory by associating each of the data objects with a color that represents a row in the memory and wherein generating the adapted interference graph includes remapping at least one of the data objects to a different color that represents a different row in the memory.

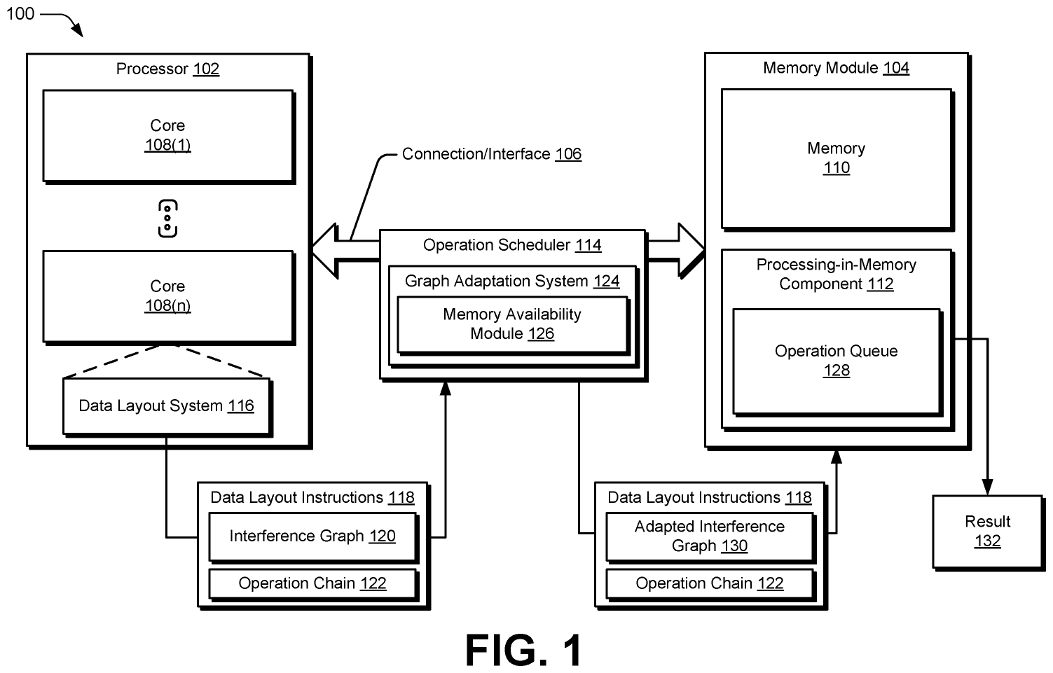

FIG. 1 is a block diagram of a system 100 that includes a processor with at least one core, a memory module with a memory and a PIM component, and an operation scheduler configured to grant requests by the processor for the PIM component to perform transactions. In particular, the system 100 includes processor 102 and memory module 104, where the processor 102 and the memory module 104 are communicatively coupled via connection/interface 106. In one or more implementations, the processor 102 includes at least one core 108. In some implementations, the processor 102 includes multiple cores 108. For instance, in the illustrated example of FIG. 1, processor 102 is depicted as including core 108(1) and core 108(n), where n represents any integer. The memory module 104 includes memory 110 and processing-in-memory component 112. Although illustrated in FIG. 1 and described in the context of allocating data stored in memory 110 for processing by a PIM component, the techniques described herein are not so limited, and are extendable to any computer architecture that implements non-uniform memory access.

In accordance with the described techniques, the processor 102 and the memory module 104 are coupled to one another via a wired or wireless connection, which is depicted in the illustrated example of FIG. 1 as the connection/interface 106. Example wired connections include, but are not limited to, buses (e.g., a data bus), interconnects, traces, and planes. Examples of devices in which the system 100 is implemented include, but are not limited to, supercomputers and/or computer clusters of high-performance computing (HPC) environments, servers, personal computers, laptops, desktops, game consoles, set top boxes, tablets, smartphones, mobile devices, virtual and/or augmented reality devices, wearables, medical devices, systems on chips, and other computing devices or systems.

The processor 102 is an electronic circuit that performs various operations on and/or using data in the memory 110. Examples of the processor 102 and/or a core 108 of the processor include, but are not limited to, a CPU, a GPU, a field programmable gate array (FPGA), an accelerated processing unit (APU), and a digital signal processor (DSP). For example, in one or more implementations a core 108 is a processing unit that reads and executes instructions (e.g., of a program), examples of which include to add data, to move data, and to branch data.

In one or more implementations, the memory module 104 is a circuit board (e.g., a printed circuit board), on which the memory 110 is mounted and includes the processing-in-memory component 112. In some variations, one or more integrated circuits of the memory 110 are mounted on the circuit board of the memory module 104, and the memory module 104 includes one or more processing-in-memory components 112. Examples of the memory module 104 include, but are not limited to, a TransFlash memory module, a single in-line memory module (SIMM), and a dual in-line memory module (DIMM). In one or more implementations, the memory module 104 is a single integrated circuit device that incorporates the memory 110 and the processing-in-memory component 112 on a single chip. In some examples, the memory module 104 is composed of multiple chips that implement the memory 110 and the processing-in-memory component 112 that are vertically (“3D”) stacked together, are placed side-by-side on an interposer or substrate, or are assembled via a combination of vertical stacking or side-by-side placement.

The memory 110 is a device or system that is used to store information, such as for immediate use in a device (e.g., by a core 108 of the processor 102 and/or by the processing-in-memory component 112). In one or more implementations, the memory 110 corresponds to semiconductor memory where data is stored within memory cells on one or more integrated circuits. In at least one example, the memory 110 corresponds to or includes volatile memory, examples of which include random-access memory (RAM), dynamic random-access memory (DRAM), synchronous dynamic random-access memory (SDRAM), and static random-access memory (SRAM).

In some implementations, the memory 110 corresponds to or includes a cache memory of the core 108 and/or the processor 102 such as a level 1 cache, a level 2 cache, a level 3 cache, and so forth. For example, the memory 110 represents high bandwidth memory (HBM) in a 3D-stacked implementation. Alternatively or additionally, the memory 110 corresponds to or includes non-volatile memory, examples of which include solid state disks (SSD), flash memory, read-only memory (ROM), programmable read-only memory (PROM), erasable programmable read-only memory (EPROM), and electronically erasable programmable read-only memory (EEPROM). The memory 110 is thus configurable in a variety of ways without departing from the spirit or scope of the described techniques.

The processing-in-memory component 112 is configured to process processing-in-memory operations involved as part of one or more transactions or computational tasks (e.g., operations of a transaction received from the core 108 via the connection/interface 106). The processing-in-memory component 112 is representative of a circuit (e.g., a processor) with example processing capabilities ranging from relatively simple (e.g., an adding machine) to relatively complex (e.g., a CPU/GPU compute core). In an example, the processing-in-memory component 112 processes the one or more transactions by executing associated operations using data stored in the memory 110.

Processing-in-memory contrasts with standard computer architectures which obtain data from memory, communicate the data to a remote processing unit (e.g., a core 108 of the processor 102), and process the data using the remote processing unit (e.g., using a core 108 of the processor 102 rather than the processing-in-memory component 112). In various scenarios, the data produced by the remote processing unit as a result of processing the obtained data is written back to memory, which involves communicating the produced data over the connection/interface 106 from the remote processing unit to memory. In terms of data communication pathways, the remote processing unit (e.g., a core 108 of the processor 102) is further away from the memory 110 than the processing-in-memory component 112, both physically and topologically. As a result, conventional computer architectures suffer from increased data transfer latency, reduced data communication bandwidth, and increased data communication energy, particularly when the volume of data transferred between the memory and the remote processing unit is large, which can also decrease overall computer performance.

Thus, the processing-in-memory component 112 enables increased computer performance while reducing data transfer energy as compared to standard computer architectures that implement remote processing hardware. Further, the processing-in-memory component 112 alleviates memory performance and energy bottlenecks by moving one or more memory-intensive computations closer to the memory 110. Although the processing-in-memory component 112 is illustrated as being disposed within the memory module 104, in some examples, the described benefits of memory verification using processing-in-memory are realizable through near-memory processing implementations in which the processing-in-memory component 112 is disposed in closer proximity to the memory 110 (e.g., in terms of data communication pathways) than a core 108 of the processor 102.

The system 100 is further depicted as including an operation scheduler 114. The operation scheduler 114 is representative of a system component (e.g., a component implementing one or more software layers) configured to allocate addresses in memory 110 based on an interference graph generated in accordance with the techniques described herein. The operation scheduler 114, for instance, is configured to allocate memory addresses at a granularity of a super row that spans all banks of the memory 110 based on address mappings derived from an interference graph. The operation scheduler 114 is further configured to receive requests for performance of one or more operations from the processor 102 (e.g., from a core 108 of the processor 102). In some implementations, the requests are representative of a sequence of operations that are executed as part of performing a computational task, such as a sequence of PIM operations that the processor 102 requests the operation scheduler 114 to schedule for performance by the processing-in-memory component 112.

Although depicted in the example system 100 as being implemented separately from the processor 102, in some implementations the operation scheduler 114 is implemented locally as part of the processor 102. The operation scheduler 114 is further configured to schedule requests for performance of operations from a plurality of processors, despite being depicted in the illustrated example of FIG. 1 as serving only a single processor 102. For instance, in an example implementation the operation scheduler 114 schedules requests for performance of operations received from a plurality of different processors, where each of the plurality of different processors include one or more cores that send operations to the operation scheduler 114 for scheduling with the memory module.

In accordance with one or more implementations, the operation scheduler 114 is associated with a single channel of the memory 110. For instance, the system 100 is configured to include a plurality of different operation schedulers 114, one for each of a plurality of channels of memory 110. The techniques described herein are thus performable using a plurality of different operation schedulers to schedule performance of operations using data stored in different channels of memory 110. In some implementations, a single channel in memory 110 is allocated into multiple pseudo-channels. In such implementations, the operation scheduler 114 is configured to schedule operations using data stored in for different pseudo-channels of a single channel in the memory 110.

As depicted in the illustrated example of FIG. 1, the processor 102 includes a data layout system 116. The data layout system 116 is representative of logic configured to generate data layout instructions 118 for a computational task. The data layout instructions 118 represent instructions for storing various data objects that are used to execute, as well as data objects that are generated from executing, a sequence of operations involved in performing the computational task. Specifically, the data layout instructions 118 define a location in memory for each of a plurality of data objects that are involved in (e.g., used to execute and generated from executing) the sequence of operations defined by the computational task. Advantageously, the data layout instructions define memory locations for data objects in a manner that is tailored to a system architecture of a system used to perform the computational task, such as a system architecture of the memory module 104. For instance, the data layout system 116 generates the data layout instructions 118 based on characteristics of the memory 110 storing data involved in the sequence of operations and the processing-in-memory component 112 used to execute the sequence of operations for a computational task.

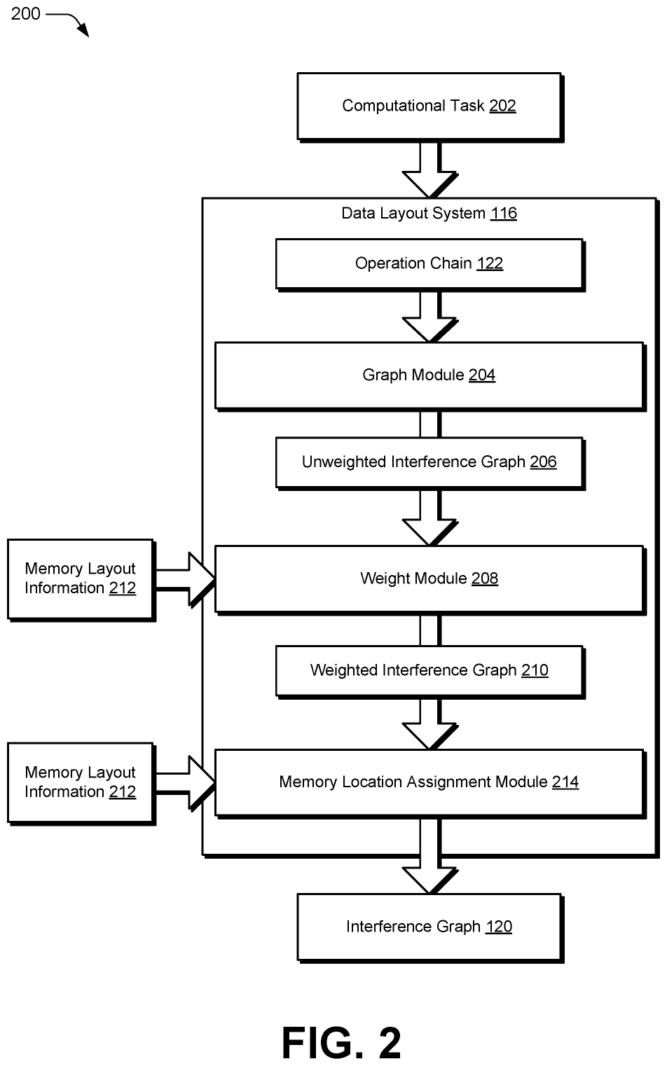

The data layout instructions 118 are depicted as including an interference graph 120 and an operation chain 122 for a given computational task. The operation chain 122 is representative of a sequence of operations that are executed by the processing-in-memory component 112, using data stored in the memory 110, as part of performing the computational task. The interference graph 120 is generated by the data layout system 116 based on the specific sequence of operations defined by the operation chain 122 as well as a system architecture of the system being used to execute the operation chain 122 (e.g., a system architecture of the memory module 104). The interference graph 120 is representative of information describing different data objects processed and generated as part of executing the operation chain 122. Additionally, the interference graph 120 includes information describing a computational cost associated with storing different data objects, which are involved in a common operation of the operation chain 122, in a same bank of the memory 110 that is accessible by the processing-in-memory component 112. A further description of generating the interference graph 120 and information included in the interference graph 120 is described below with respect to FIGS. 2-4.

The data layout instructions 118 thus define a storage location in memory 110 for each data object involved in executing the operation chain 122, such that the memory module 104 is informed as to how data should be organized both prior to the processing-in-memory component 112 executing the operation chain 122 and as a result of executing one or more operations in the operation chain 122. Advantageously, the data layout instructions 118 define a data layout for a given computational task in a manner that reduces a time required to complete execution of the operation chain 122 and reduces computational resources required to execute the operation chain 122. The data layout instructions 118 are then communicated by the data layout system 116 to the graph adaptation system 124 implemented at the operation scheduler 114. Although illustrated as being implemented at the processor 102, in some implementations the data layout system 116 is implemented at the operation scheduler 114. Regardless of a location at which the data layout system 116 is implemented, the data layout system 116 is configured to generate the data layout instructions 118 at compile time for the computational task represented by the operation chain 122.

The graph adaptation system 124 is depicted as including a memory availability module 126. The memory availability module 126 is representative of functionality of the graph adaptation system 124 to determine whether a current or scheduled processing load of the processing-in-memory component 112 enables organizing data involved in executing the operation chain 122 as specified by the data layout instructions 118 generated by the data layout system 116. For instance, the memory availability module 126 is configured to ascertain information maintained in an operation queue 128 of the processing-in-memory component 112 scheduled to execute the operation chain 122. The operation queue 128 is representative of a data storage structure in the processing-in-memory component 112 that maintains an ordered list of operations scheduled for sequential execution by the processing-in-memory component 112 using data stored in memory 110.

Using information stored in the operation queue 128, the memory availability module 126 is configured to determine whether memory locations identified by the data layout instructions 118 are available to store data objects involved in executing the operation chain 122 at the corresponding storage locations indicated by the interference graph 120. In response to identifying that data storage locations in the memory 110, as indicated by the interference graph 120, are available to maintain data objects involved in executing the operation chain 122, the operation scheduler 114 schedules the operation chain 122 for execution by the processing-in-memory component 112 by inserting the operation chain 122 into the operation queue 128. The operation scheduler 114 additionally instructs the memory module 104 to store data objects involved in execution of the operation chain 122 at storage locations in memory 110 as defined by the interference graph 120.

Alternatively, in response to the memory availability module 126 identifying that the data storage locations in the memory 110, as defined by the interference graph 120, are unavailable to store the data objects involved in executing the operation chain 122, the graph adaptation system 124 generates an adapted interference graph 130. The memory availability module 126 is configured to determine availability of storage locations in the memory 110 at runtime of the operation chain 122, and is thus configured to identify conditions that render one or more storage locations in memory unavailable which may have not been present or otherwise undetectable upon compiling the operation chain 122.

For instance, the memory availability module 126 is configured to identify unavailability of one or more memory locations identified by the interference graph 120 in response to operations for another computational task being enqueued at the operation queue 128 involving memory locations otherwise scheduled for reservation by the interference graph 120. The graph adaptation system 124 is thus configured to generate the adapted interference graph 130 in a manner similar to how the data layout system 116 generates the interference graph 120, based on conditions of the memory module 104 at runtime for the computational task defined by the operation chain 122. If memory storage locations for data objects, as defined by the interference graph 120, are unavailable at runtime, the graph adaptation system 124 generates the adapted interference graph 130 and replaces the interference graph 120 with the adapted interference graph 130 in the data layout instructions 118. The operation scheduler 114 then schedules the operation chain 122 for execution by the processing-in-memory component 112 by inserting the operation chain 122 into the operation queue 128. The operation scheduler 114 additionally instructs the memory module 104 to store data objects involved in execution of the operation chain 122 at storage locations in memory 110 as defined by the adapted interference graph 130.

As part of executing each operation in the operation chain 122, the processing-in-memory component 112 generates a result 132 that includes data generated from processing data stored in the memory 110 according to the operation of the operation chain 122. The interference graph included in the data layout instructions 118 (e.g., the interference graph 120 or the adapted interference graph 130) include instructions specifying how the processing-in-memory component 112 outputs the result 132. Outputting the result 132 is configurable in a variety of manners.

For instance, in some implementations executing one or more operations in the operation chain 122 causes the processing-in-memory component 112 to communicate the result 132 to a requesting source for the transaction (e.g., the processor 102). Alternatively or additionally, in some implementations the data layout instructions 118 cause the processing-in-memory component 112 to output the result 132 to a defined storage location in memory 110 (e.g., to update data stored in memory 110, for use in executing a subsequent operation of the operation chain 122, for subsequent access and/or retrieval by the processor 102, and so forth). Alternatively or additionally, in some implementations instructions included in the data layout instructions 118 cause the processing-in-memory component 112 to store the result 132 locally (e.g., in a register of the processing-in-memory component 112).

Because the processing-in-memory component 112 executes operations of the operation chain 122 on behalf of the processor 102, the processing-in-memory component 112 is configured to execute the operation chain 122 with minimal impact on the system 100 (e.g., without invalidating caches of the system 100 or causing traffic on the connection/interface 106). For instance, the processing-in-memory component 112 executes the operation chain 122 using data stored in memory 110 “in the background” with respect to the processor 102 and the core 108, which frees up cycles of the processor 102 and/or the core 108, reduces memory bus traffic (e.g., reduces traffic on the connection/interface 106), and reduces power consumption relative to performing operations at the processor 102 and/or the core 108. Notably, because the processing-in-memory component 112 is closer to the memory 110 than the core 108 of the processor 102 in terms of data communication pathways, executing the operation chain 122 using data stored in memory 110 is generally completable in a shorter amount of time using the processing-in-memory component 112 than if the operation chain 122 were executed by the core 108 of the processor 102.

FIG. 2 depicts an example 200 of generating an interference graph for a computational task.

The example 200 is depicted as including the data layout system 116 as introduced above with respect to FIG. 1. In the example 200, the data layout system 116 is depicted as receiving a computational task 202 to be performed by a processing device in a non-uniform memory access architecture (e.g., to be performed by the processing-in-memory component 112). The data layout system 116 is configured to identify a sequence of operations to be executed by the processing-in-memory component 112 as part of performing the computational task 202, which is represented as the operation chain 122.

In implementations, the data layout system 116 is configured to derive the operation chain 122 for the computational task 202 by implementing a compiler (e.g., a PIM-aware compiler) that identifies operations involved in the computational task 202, data objects used to perform individual ones of the operations in the operation chain 122, and data objects generated as a result of performing operations in the operation chain 122. Alternatively or additionally, in some implementations the data layout system 116 is configured to derive the operation chain 122 for the computational task 202 by executing the computational task 202 and monitoring execution of the computational task 202 to determine what operations and data objects are involved in performing the computational task 202.

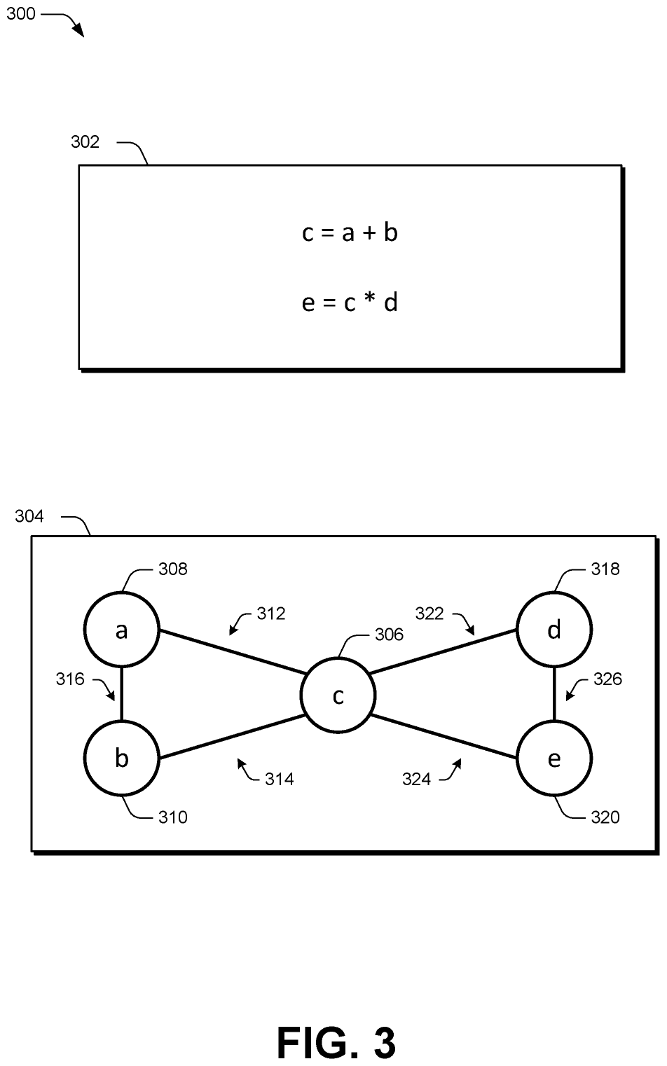

The data layout system 116 then provides the operation chain 122 to a graph module 204, which is configured to construct an unweighted interference graph 206 for the computational task 202, using the operation chain 122. The unweighted interference graph 206 is representative of information describing how different data objects used to perform various operations in the operation chain 122, or generated as a result from performing one or more operations of the operation chain 122 are related to one another. For a detailed description the graph module 204 generating the unweighted interference graph 206, consider FIG. 3.

FIG. 3 depicts an example 300 of a sequence of operations performed as part of a computational task and an unweighted interference graph generated from the sequence of operations.

For instance, the illustrated example 300 depicts an example operation chain 302 and an unweighted interference graph 304 generated from the operation chain 302. In this manner, the operation chain 302 represents an example of the operation chain 122 for a computational task and the unweighted interference graph 304 represents an instance of the unweighted interference graph 206 generated from the operation chain 122. The operation chain 302 is depicted as including a sequence of two operations, where a first operation is defined as c=a+b and a second operation is defined as e=c*d. Data objects involved in the operation chain 302 are thus defined as a, b, c, d, and e.

The graph module 204 is configured to generate the unweighted interference graph 304 by representing each data object included in the operation chain 302 as a node. For instance, data object c is represented as node 306, data object a is represented as node 308, and data object b is represented as node 310. The graph module 204 further generates the unweighted interference graph 304 by establishing an edge between a node pair if the two data objects represented by the node pair are involved in a common operation from the operation chain 302. For instance, data objects a and b are summed to compute data object c in the first operation, thus edges are established between each pair of data objects involved in the first operation. Specifically, the graph module 204 generates the unweighted interference graph 304 by establishing edge 312 between node 306 and node 308, establishing edge 314 between node 306 and node 310, and establishing edge 316 between node 308 and node 310.

To complete the unweighted interference graph 304, the graph module 204 continues adding nodes and edges to represent additional operations in the operation chain 302. For instance, the graph module 204 adds node 318 to represent data object d and adds node 320 to represent data object e. Because data objects c, d, and e are involved in the second operation (e=c*d), edges are established between each pair of data objects c, d, and e. Specifically, the graph module 204 establishes edge 322 between node 306 and node 318, establishes edge 324 between node 306 and node 320, and establishes edge 326 between node 318 and node 320.

Returning to FIG. 2, the graph module 204 provides the unweighted interference graph 206 for the operation chain 122 to a weight module 208 of the data layout system 116. The weight module 208 is configured to generate a weighted interference graph 210 from the unweighted interference graph 206 by assigning a weight value to each edge included in the unweighted interference graph 206.

The weight module 208 is configured to assign a weight value to each edge included in the unweighted interference graph 206 based on memory layout information 212 that describes architectural conditions of the memory 110 in which data objects involved in the operation chain 122 for the computational task 202 are to be stored. For instance, the memory layout information 212 is representative of information that describes a size of a memory row (e.g., a row of a DRAM bank) in which data objects are stored. In some implementations, the memory layout information 212 is further representative of information that describes a storage size of a local storage component for a processing device that will perform the computational task 202 (e.g., a size of a register of the processing-in-memory component 112).

In some implementations, the memory layout information 212 describes one or more address interleaving patterns used by the operation scheduler 114 for hashing data storage locations in the memory 110. For instance, the memory layout information 212 includes information describing an address interleaving pattern achieved by performing address hashing using at least a portion of a row identifier for a row in memory that returns channel and bank identifiers for a storage location in memory 110, such as the address hashing techniques described in U.S. patent application Ser. No. 17/956,955, filed Sep. 30, 2022, the disclosure of which is hereby incorporated by reference in its entirety.

The memory layout information 212 is thus useable by the data layout system 116 to ascertain information describing a respective address interleaving pattern for each super row of the memory 110, where a super row is representative of a virtual row that spans all banks of the memory. In implementations, the memory layout information 212 represents super rows by colors, such that each super row is assigned a color, where an address interleaving pattern associated with one color may be different from an address interleaving pattern associated with a different color. The memory layout information 212 is further representative of information describing one or more color groups in the memory 110, where a color group represents a group of different super rows in memory 110 that follow a common PIM interleaving pattern.

Being informed of an architectural layout of memory 110 used to store data objects involved in executing the operation chain 122 of the computational task 202, as well as memory layout information 212 for the memory module 104, the weight module 208 is configured to generate a weighted interference graph 210 in a manner that is useable to optimize data object allocation among super rows of the memory 110.

The weight module 208 is configured to compute a cost of mapping data objects of two connected nodes in the unweighted interference graph 206 to a common bank in the memory 110 and assign a value representing the computed cost to an edge that connects the two nodes in the unweighted interference graph 206. In implementations where the memory layout information 212 categorizes different super rows of memory 110 based on color, the weight module 208 computes a computational cost that would be incurred by the processing-in-memory component 112 if two data objects represented by connected nodes to a same color row in the memory 110. The value assigned to an edge in the weighted interference graph 210 is thus representative of a metric representing a “cost” of assigning a same color to the two nodes connected by an edge. For instance, in one example the value assigned to an edge represents a number of bank conflicts that would occur during performance of the computational task 202 if the data objects connected by the edge were assigned storage locations in a common memory bank.

Specifically, the weight module 208 computes an edge weight according to Equation 1:

$$W = ( ( 2 n + 1 ) * m - 1 ) * k \qquad ( Eq . 1 )$$

In Equation 1, W represents a value assigned to an edge in the weighted interference graph 210, n represents ratio of a row size in the memory 110 relative to a local storage component of a processing device executing the operation chain 122, and m represents how many rows in memory 110 are required to store the data objects represented by nodes connected via the edge to which W is assigned, In Equation 1, k represents a number of times that an operation represented in the operation chain 122 is executed during the operation chain 122.

For instance, with respect to the illustrated example of FIG. 1, n is a value that represents when a certain row in memory 110 is opened, how many times data must be read into a register of the processing-in-memory component 112 in order for the processing-in-memory component 112 to fully read data stored in the certain row. As an example, if a register of the processing-in-memory component 112 is half the size of a row in memory 110, then data from the row will have to be read twice into the register of the processing-in-memory component 112 to be fully read, and the value of n becomes two in this example. As another example, if a size of one or more registers of the processing-in-memory component 112 is greater than or equal to a size of a row in memory 110, then the value of n becomes one.

The value of m is dependent on a size of data objects represented by nodes connected via an edge, and represents an integer number of rows that the two data objects will span when stored in memory 110. In this manner, two small data objects that are connected nodes in the unweighted interference graph 206 and that can be stored in a single row of memory 110 result in a value of m=1 when computing the edge weight for the edge connecting two nodes. As another example, if two larger connected data objects require five rows in memory 110 for storage, computing the edge weight for the two larger data objects is performed with a value of m=5. The value represented by m thus enables the weight module 208 to account for a number of row switches that would occur if data objects represented by connected nodes were stored in the same bank in memory 110.

After computing edge weights for each of the edges included in the unweighted interference graph 206, the weight module 208 outputs the weighted interference graph 210 to a memory location assignment module 214. The memory location assignment module 214 is representative of a color-aware memory allocator configured to assign locations in memory 110 for storing data objects represented in the weighted interference graph 210 prior to, during, and/or following performance of the computational task 202 in a manner that enables optimal execution of the operation chain 122 by the processing-in-memory component 112.

In assigning locations in memory 110 for storage of data objects involved in executing the operation chain 122, the memory location assignment module 214 leverages both edge weights set forth in the weighted interference graph 210 and information described in the memory layout information 212. For instance, in some implementations the memory location assignment module 214 assigns data objects storage locations in memory 110 that are constrained to a color group defined by memory layout information 212, such that data objects for an operation chain 122 are stored in rows of memory 110 in a manner that satisfies PIM locality and row-buffer locality simultaneously. In some implementations, a number of colors available for assignment to nodes of the weighted interference graph 210 corresponds to a number of memory banks in a memory channel that implements the processing-in-memory component 112. For instance, in an example scenario where the processing-in-memory component 112 is implemented in a DRAM channel with two banks, a color group includes two colors and nodes of the weighted interference graph 210 can be assigned one of the two colors.

For a given color group, the memory location assignment module 214 seeks to assign different colors to connected nodes in the weighted interference graph 210. In an ideal scenario, no two connected nodes in the weighted interference graph 210 are assigned a same color, meaning that no two nodes involved in a common operation of the operation chain 122 are located in the same bank in memory 110. This ideal scenario enables the processing-in-memory component 112 to perform the computational task 202 without any bank conflicts, thereby optimizing system performance during the computational task 202. However, system architecture constraints often preclude the memory location assignment module 214 from assigning different colors to each pair of connected nodes in the weighted interference graph 210. Accordingly, the memory location assignment module 214 is configured to assign colors to nodes in the weighted interference graph 210 in a manner that minimizes an overall cost of arranging data objects in memory for execution of the operation chain 122.

An overall cost associated with arranging data objects in memory for execution of the operation chain 122 is defined as the cumulative value of edge weights for nodes in the weighted interference graph 210 that are assigned a same color. In some implementations, the memory location assignment module 214 is configured to exhaustively consider all possible coloring strategies for the weighted interference graph 210 and output a color strategy that minimizes an overall cost for the computational task 202. However, while this exhaustive coloring strategy approach is suitable for some computational tasks that include relatively short operation chains and relatively few available colors for a color group specified by the memory layout information 212, the computational cost becomes prohibitive when scaled to larger operation chains, larger amounts of available colors for a color group, or combinations thereof.

Accordingly, in some implementations the memory location assignment module 214 is configured to prioritize nodes in the weighted interference graph 210 for coloring based on a combined weight of all edges connected to a node. For instance, the memory location assignment module 214 rank nodes in the weighted interference graph 210 based on a combined weight that represents a sum of all edge weights for edges connected to a node. The greatest (e.g., largest) combined edge weight indicates a most significant impact on system performance during execution of the operation chain 122. Given a set of available colors (e.g., an amount of different colors that corresponds to an amount of different memory banks of a DRAM channel implementing the processing-in-memory component 112), the memory location assignment module 214 selects a most important node and assigns a first color to the most important node. The memory location assignment module 214 then proceeds to identify the next most important node connected via an edge to the previously colored node and assigns that next most important node a different color.

In scenarios where the memory location assignment module 214 is unable to assign a color to a node that is different than a color of any other connected node, the memory location assignment module 214 selects a color that minimizes an overall cost of doing so, where the overall cost is quantified based on the edge weight of an edge connecting the node to one or more other nodes assigned the same color. In implementations where there is a tie of assigning one of two or more colors to a node (e.g., an equivalent overall cost), the memory location assignment module 214 randomly selects among the two or more colors and assigns the randomly selected color to the node.

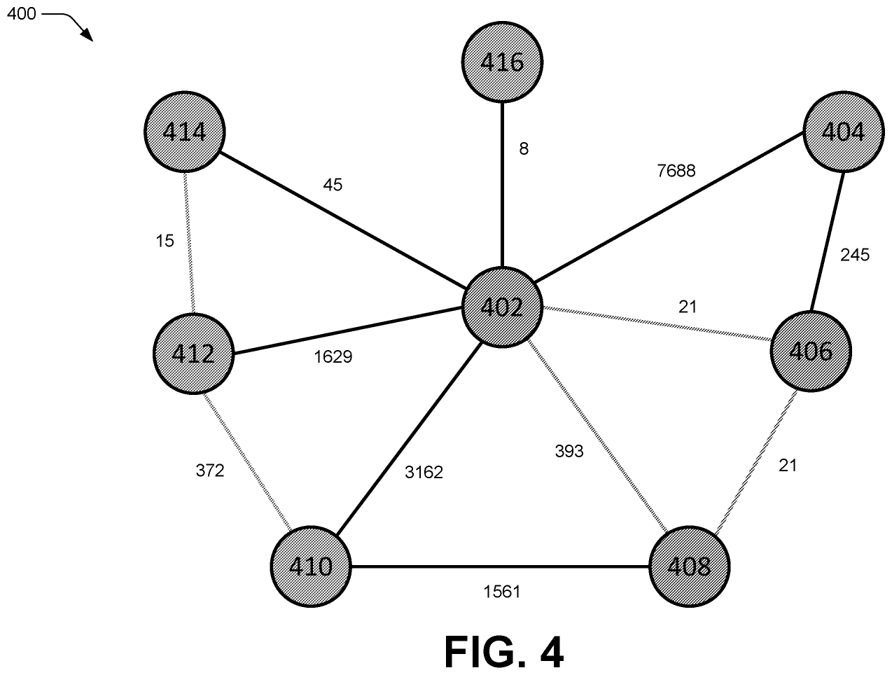

This process continues until all nodes in the weighted interference graph 210 are assigned a color, at which point the memory location assignment module 214 outputs the weighted interference graph 210 with colored nodes as the interference graph 120. Although described herein with respect to assigning colors to nodes of the weighted interference graph 210, where colors represent rows in memory 110 to which data objects are assigned, the memory location assignment module 214 is configured to assign any suitable form of location information to a node in the weighted interference graph 210 (e.g., a row identifier) in accordance with the described techniques. The interference graph 120 is thus representative of information describing all data objects involved in executing the operation chain 122 for a computational task 202, together with address information describing a respective storage location in memory 110 for each of the data objects, that enables optimal performance of the computational task 202 by the processing-in-memory component 112. For a further description of an interference graph 120 generated by the data layout system 116, consider FIG. 4.

FIG. 4 depicts an example 400 of an interference graph for a computational task.

In the illustrated example 400, the interference graph includes node 402, node 404, node 406, node 408, node 410, node 412, node 414, and node 416. Node 402 is connected via respective edges to each of nodes 404, 406, 408, 412, 414, and 416, indicating that the data object represented by node 402 is involved in each operation for a computational task 202 (e.g., each operation in the operation chain 122). The edges connecting various ones of the nodes 402, 404, 406, 408, 412, 414, and 416 are each depicted as having an associated edge weight computed by the weight module 208.

For instance, the edge connecting node 402 and node 404 has an assigned weight of 7688. The edge connecting node 402 and node 406 has an assigned weight of 21. The edge connecting node 402 to node 408 has an assigned weight of 393. The edge connecting node 402 to node 410 has an assigned weight of 3162. The edge connecting node 402 to node 412 has an assigned weight of 1629. The edge connecting node 402 to node 414 has an assigned weight of 45. The edge connecting node 402 to node 416 has an assigned weight of 8. Accordingly, the combined edge weight for node 402 is calculated by the memory location assignment module 214 as 7688+21+393+3162+1629+45+8, which results to a combined edge weight of 12946. Combined edge weights for other nodes are computed in a similar manner, such that node 404 has a combined edge weight of 7933, node 406 has a combined edge weight of 287, node 408 has a combined edge weight of 1975, node 410 has a combined edge weight of 5095, node 412 has a combined edge weight of 2016, node 414 has a combined edge weight of 60, and node 416 has a combined edge weight of 8.

Because node 402 has the greatest combined edge weight in the illustrated example 400, the memory location assignment module 214 first assigns a color to the node 402. In the illustrated example 400, available colors for assignment (e.g., as indicated by the memory layout information 212) include red and green. Accordingly, the memory location assignment module 214 assigns the node 402 a color red. The memory location assignment module 214 then proceeds to identify a next most important node connected to node 402 based on a respective combined edge weight, which is node 404 in the illustrated example 400. Guided under the objective to assign different colors to connected nodes, the memory location assignment module 214 assigns node 404 the color green to differentiate from the red color assigned to node 402.

This color assignment procedure continues to the next most important node connected to node 402, which is node 410, which is also assigned the color green. After coloring nodes 402, 404, and 410, the next most important node becomes node 412. However, because node 412 cannot be assigned a color that is different from both the color already assigned to connected node 402 and connected node 410, the memory location assignment module 214 assigns a color to node 412 based on a minimum edge weight of an edge that connects node 412 to a previously colored node. In the illustrated example 400, coloring node 412 as green is associated with an overall cost of 372, via the edge connecting node 412 to green node 410, while coloring node 412 as red is associated with an overall cost of 1629, as indicated by the edge connecting node 412 to red node 402. Accordingly, the memory location assignment module 214 assigns node 412 the color green to minimize an overall cost of executing the operation chain 122 represented by the interference graph 120 of FIG. 4.

The coloring process continues to the next most important node, node 408, which is colored red due to the edge connecting node 408 with node 402 having a value of 393, which is less than the value of 1561 represented by the edge connecting node 408 to node 410. Node 406 is then colored red to incur a lower overall cost than would be incurred by coloring node 406 green (e.g., 21+21<245). In a similar manner, node 414 is colored green due to the edge weight connecting node 414 with node 412 being less than the edge weight connecting node 414 with node 402. Finally, node 416 is colored green to differentiate from the red color assigned to node 402.

The data layout system 116 is thus configured to assign a location in memory to respective data objects involved in an operation chain 122 for a computational task 202 in a manner that minimizes an overall computational cost associated with performing the computational task 202, thus improving system performance. Address information for a location in memory 110 at which each data object is to be stored is encoded in the interference graph 120 and communicated by the data layout system 116, together with the operation chain 122 to the operation scheduler 114, upon compiling the computational task 202 for execution by the processing-in-memory component 112.

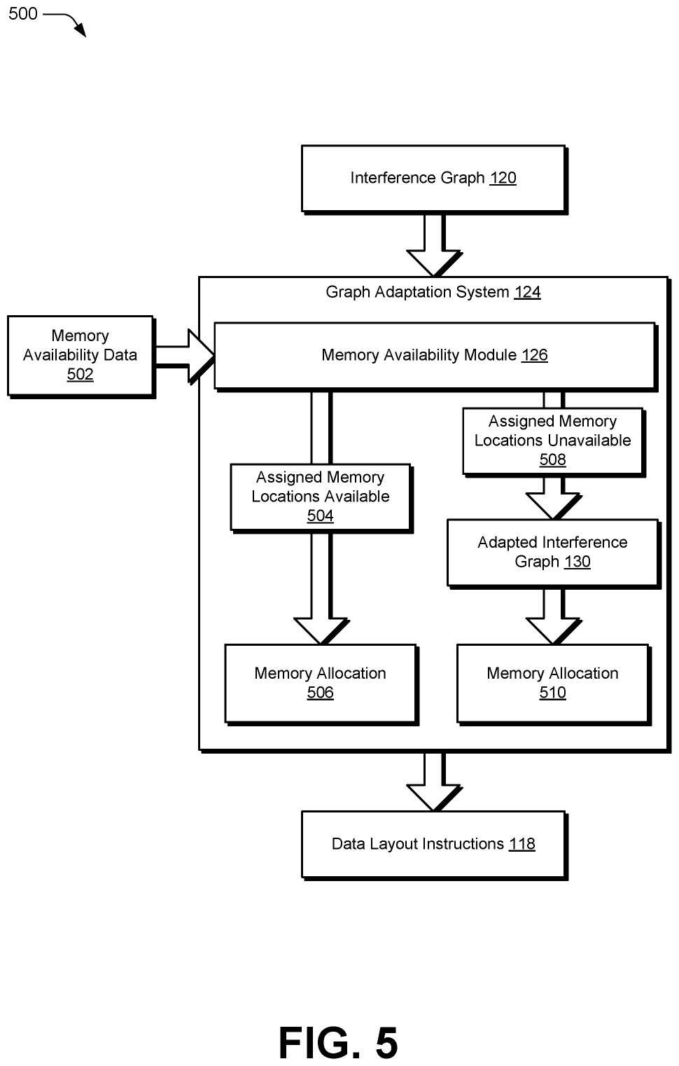

To ensure that the interference graph 120 represents an optimal layout of data objects in memory 110 for execution of the operation chain 122 by the processing-in-memory component 112 at runtime, the graph adaptation system 124 is configured to verify that a current or scheduled load of the processing-in-memory component 112 is able to allocate data objects according to the interference graph 120. For a further description of functionality of the graph adaptation system 124, consider FIG. 5.

FIG. 5 depicts an example 500 of generating data layout instructions for a computational task using a weighted interference graph for the computational task.

As depicted in the illustrated example 500, the graph adaptation system 124 receives the interference graph 120 as part of the data layout instructions 118 from the data layout system 116. Upon receipt of the interference graph 120, the memory availability module 126 determines whether the locations in memory 110 assigned to different data objects involved in execution of the operation chain 122 are available based on a scheduled processing load for the processing-in-memory component 112. To do so, the memory availability module 126 obtains memory availability data 502, which is representative of information describing available space in memory 110.

Based on the memory availability data 502, the memory availability module 126 determines whether there are sufficient pages in respective rows of memory 110 to store data objects of the interference graph 120. For instance, the memory availability module 126 determines whether there are sufficient available pages in rows that correspond to a red color assignment in memory 110 to store data objects represented by nodes 402, 406, and 408 in the illustrated example of FIG. 4. Similarly, the memory availability module 126 determines whether there are sufficient available pages in rows that correspond to a green color assignment in memory 110 to store data objects represented by nodes 404, 410, 412, 414, and 416 in the illustrated example of FIG. 4.

In response to a determination 504 that assigned rows in memory 110 are available, the memory availability module 126 generates a memory allocation 506 for data objects represented in the interference graph 120 using the data storage locations assigned by the memory location assignment module 214. The memory allocation 506 is thus representative of one or memory allocation calls to be processed by a system memory allocator (e.g., by the operation scheduler 114) prior to execution of the operation chain 122 and ensures that data objects involved in the computational task 202 are positioned in memory 110 in a manner that optimizes performance of the system 100.

Alternatively, in a scenario where the memory availability module 126 outputs a determination 508 that rows of memory 110, as assigned by the interference graph 120, are unavailable at runtime of the operation chain 122, the graph adaptation system 124 proceeds to generate an adapted interference graph 130. To do so, the graph adaptation system 124 remaps colors assigned to nodes in the interference graph 120 to different colors. For instance, if there are insufficient pages in rows of memory 110 assigned a red color to accommodate data objects represented by nodes 402, 406, and 408, the graph adaptation system 124 attempts to remap the data to one or more memory rows that are assigned a different color (e.g., blue) and have sufficient pages to store the data objects represented by nodes 402, 406, and 408.

In some implementations, the graph adaptation system 124 generates the adapted interference graph 130 by recoloring individual nodes of the interference graph 120, beginning with least important nodes (e.g., as represented by overall edge weight) to most important nodes. Alternatively or additionally, the graph adaptation system 124 generates the adapted interference graph 130 by reassigning colors to large data objects represented in the interference graph 120 (e.g., data objects of a size that spans multiple super rows).

As a specific example, consider a scenario where X and Y are arrays with data objects that each span four super rows with different colors. To simultaneously optimize the data layout instructions 118 for both PIM locality and row-buffer locality considerations, array X is colored with blue, orange, green, and yellow, whereas array Y is colored with orange, blue, yellow, and green. In this example scenario, yellow and green super rows are unable to sufficiently store the respectively colored data objects of arrays X and Y, while blue and orange super rows have abundant storage to accommodate all data objects of arrays X and Y. Based on the determination 508 that indicates green and yellow super rows cannot accommodate the respective data storage objects of the interference graph 120 at runtime of the operation chain 122, the graph adaptation system 124 generates the adapted interference graph 130 by recoloring green and yellow nodes in the interference graph 120 to pages of orange and blue super rows.

Alternatively or additionally, the graph adaptation system 124 generates the adapted interference graph 130 anew from the weighted interference graph 210, using memory storage location information (e.g., super row colors) that are indicated as available at runtime by the memory availability data 502.

In response to a determination 508 that assigned rows in memory 110 are unavailable, and in response to generating an adapted interference graph 130 based on the determination 508, the memory availability module 126 generates a memory allocation 510 for data objects represented in the adapted interference graph 130. The memory allocation 510 is thus representative of one or memory allocation calls to be processed by a system memory allocator (e.g., by the operation scheduler 114) prior to execution of the operation chain 122 and ensures that data objects involved in the computational task 202 are positioned in memory 110 in a manner that optimizes performance of the system 100, based on a current and/or scheduled processing load of the system 100 at runtime for the computational task 202.

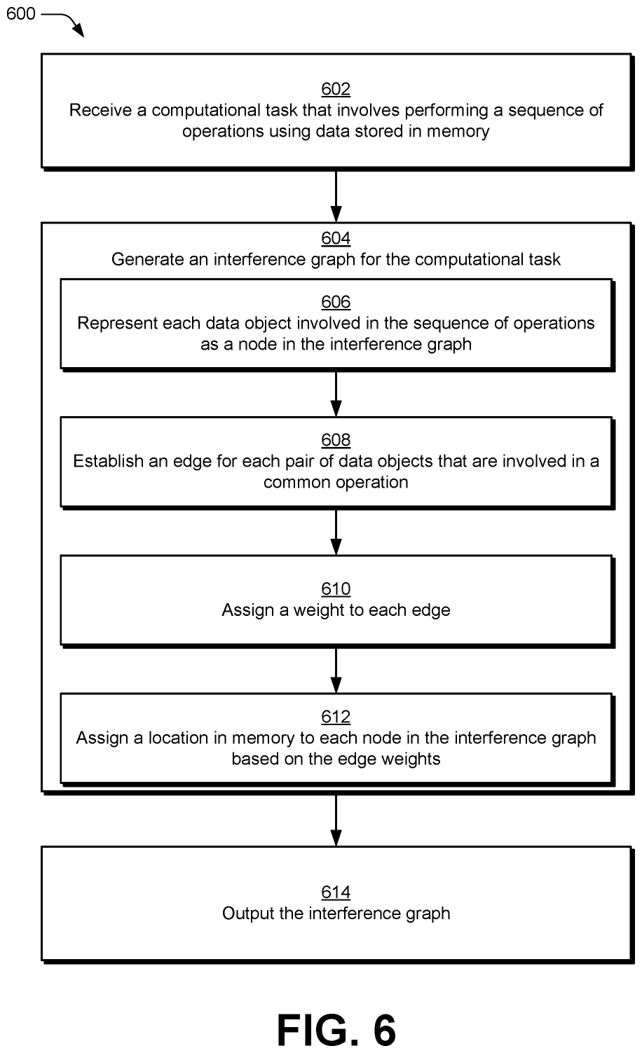

FIG. 6 depicts a procedure 600 in an example implementation of generating an interference graph for a computational task.

A computational task that involves performing a sequence of operations using data stored in memory is received (block 602). The data layout system 116, for instance, receives a computational task 202 from a core 108 of a processor 102, where the computational task 202 includes an operation chain 122 to be executed by the processing-in-memory component 112 using data stored in the memory 110.

An interference graph is then generated for the computational task (block 604). The data layout system 116, for instance, generates the interference graph 120 for the computational task 202. As part of generating the interference graph, each data object involved in the sequence of operations is represented as a node in the interference graph (block 606). The graph module 204 of the data layout system 116, for instance, identifies data objects involved in computational task 202 (e.g., processed as part of the operation chain 122, generated as a result of one or more operations in the operation chain 122, or combinations thereof). Identified data objects are represented as individual nodes in the unweighted interference graph 206.

As further part of generating the interference graph, an edge is established for each pair of data objects that are involved in a common operation (block 608). The graph module 204 of the data layout system 116, for instance, identifies different data objects that are involved in an operation of the operation chain 122 and establishes an edge connecting a pair of nodes that represent two data objects involved in the operation.

As further part of generating the interference graph, a weight is assigned to each edge in the unweighted interference graph 206 (block 610). The weight module 208 of the data layout system 116, for instance, assigns a weight to each edge in the unweighted interference graph 206 and outputs a weighted interference graph 210 that includes information describing a numerical value associated with each edge in the weighted interference graph 210. In implementations, weights are assigned to edges in the weighted interference graph 210 based on information describing architectural characteristics of a system that performs the computational task 202, such as based on architectural characteristics of the memory module 104.

As further part of generating the interference graph, a location in memory is assigned to each node in the interference graph based on the edge weights (block 612). The memory location assignment module 214, for instance, ranks nodes in the weighted interference graph 210 based on combined edge weights (e.g., the sum of all weights of edges connected to a node) and assigns a location in the memory 110 to each node, beginning with the highest ranked node (e.g., the node with the highest combined edge weight).

In some implementations, the memory location assignment module 214 assigns locations in memory to nodes by assigning a color to a node. In accordance with one or more implementations, a number of colors available for assignment corresponds to a number of banks in a memory channel that stores data involved in the computational task 202 and is accessible by a processing device executing the operation chain 122 (e.g., a number of banks in a memory channel accessible by the processing-in-memory component 112).

The interference graph is then output (block 614). The data layout system 116, for instance, outputs the interference graph 120 as part of data layout instructions 118 for the computational task 202 to the graph adaptation system 124. In accordance with one or more implementations, the data layout system 116 outputs the interference graph 120 upon compiling the operation chain 122 for the computational task 202.

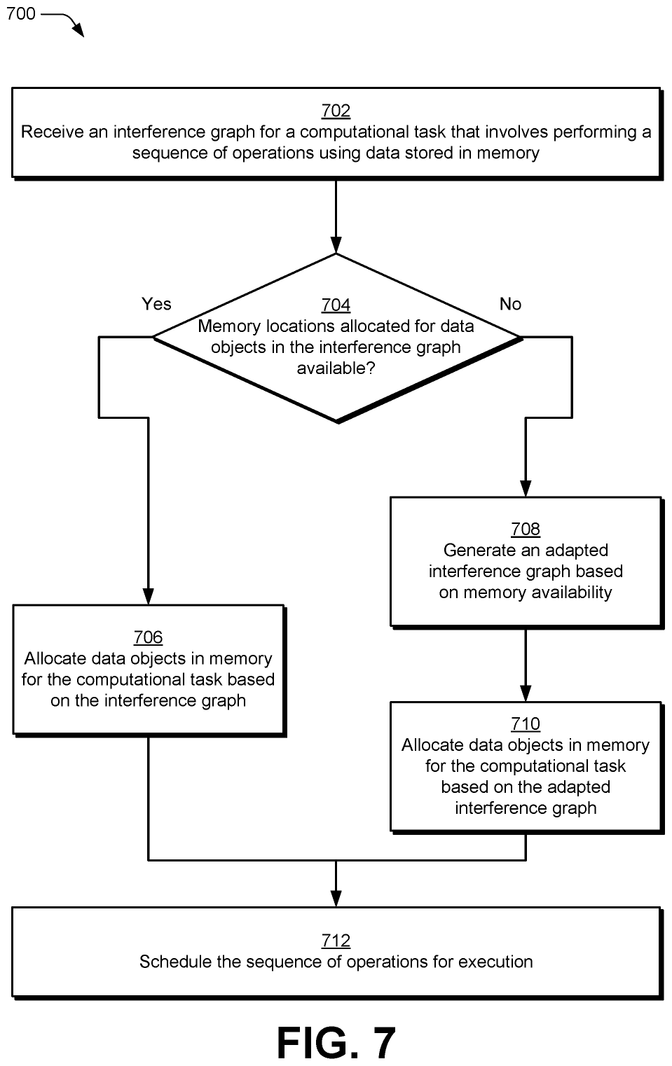

FIG. 7 depicts a procedure 700 in an example implementation of allocating data in memory for a computational task and scheduling a sequence of operations for the computational task using the allocated data in memory.

An interference graph for a computational task that involves performing a sequence of operations using data stored in memory is received (block 702). The graph adaptation system 124, for instance, receives the interference graph 120 as part of data layout instructions 118 for a computational task 202 from the data layout system 116.

A determination is made as to whether memory locations allocated for data objects in the interference are available (block 704). The memory availability module 126 of the graph adaptation system 124, for instance, obtains memory availability data 502 at runtime for the computational task 202 from which the interference graph 120 was generated and determines whether locations in memory 110 that are allocated for data objects represented by nodes of the interference graph 120 are available.

In response to determining that the memory locations allocated for data objects in the interference graph are available (e.g., a “yes” determination at block 704), data objects for the computational task are allocated in memory based on the interference graph (block 706). In response to the memory availability module 126 outputting a determination 504, for instance, the graph adaptation system 124 allocates data objects represented in the interference graph 120 according to memory allocation 506 and outputs the memory allocation 506 as part of the data layout instructions 118. In implementations, outputting the memory allocation 506 as part of the data layout instructions 118 includes outputting instructions that are executable by the memory module 104 to position data objects represented in the interference graph 120 at corresponding locations in memory 110 (e.g., within super rows of a memory channel accessible by the processing-in-memory component 112).

Alternatively, in response to determining that the memory locations allocated for data objects in the interference graph are unavailable (e.g., a “no” determination at block 704), an adapted interference graph is generated based on memory availability (block 708). In response to the memory availability module 126 outputting a determination 508, for instance, the graph adaptation system 124 generates an adapted interference graph 130.

In implementations where the graph adaptation system 124 generates an adapted interference graph 130, data objects for the computational task are allocated in memory based on the adapted interference graph (block 710). The graph adaptation system 124, for instance, allocates data objects represented in the adapted interference graph 130 according to memory allocation 510 and outputs the memory allocation 510 as part of the data layout instructions 118. In implementations, outputting the memory allocation 510 as part of the data layout instructions 118 includes outputting instructions that are executable by the memory module 104 to position data objects represented in the adapted interference graph 130 at corresponding locations in memory 110 (e.g., within super rows of a memory channel accessible by the processing-in-memory component 112).

The sequence of operations are then scheduled for execution (block 712). The operation scheduler 114, for instance, communicates the operation chain 122 to the memory module 104 and schedules the operation chain 122 for operation in the operation queue 128 of the processing-in-memory component 112. The processing-in-memory component 112 is configured to execute the operation chain 122 and output at least one result 132 as part of performing the computational task 202.

The example techniques described herein are merely illustrative and many variations are possible based on this disclosure. Although features and elements are described above in particular combinations, each feature or element is usable alone without the other features and elements or in various combinations with or without other features and elements.

The various functional units illustrated in the figures and/or described herein (including, where appropriate, the processor 102 having the core 108 and the data layout system 116, the memory module 104 having the memory 110 and the processing-in-memory component 112, and the operation scheduler 114 having the graph adaptation system 124) are implemented in any of a variety of different manners such as hardware circuitry, software or firmware executing on a programmable processor, or any combination of two or more of hardware, software, and firmware. The methods provided are implemented in any of a variety of devices, such as a general-purpose computer, a processor, or a processor core. Suitable processors include, by way of example, a general purpose processor, a special purpose processor, a conventional processor, a digital signal processor (DSP), a graphics processing unit (GPU), a parallel accelerated processor, a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

In one or more implementations, the methods and procedures provided herein are implemented in a computer program, software, or firmware incorporated in a non-transitory computer-readable storage medium for execution by a general-purpose computer or a processor. Examples of non-transitory computer-readable storage mediums include a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A system comprising:
a memory module including a memory and a processing-in-memory circuit;
a processor including at least one core configured to generate an interference graph for a computational task that assigns data objects involved in the computational task to respective locations in the memory; and
an operation scheduler configured to allocate the data objects to the respective locations in the memory and schedule the computational task for execution by the processing-in-memory circuit.

2. The system of claim 1, wherein the processor is configured to generate the interference graph automatically and independent of user input.

3. The system of claim 1, wherein the processor is configured to generate the interference graph based on a number of banks in a channel of the memory that is accessible by the processing-in-memory circuit.

4. The system of claim 1, wherein the processor is configured to generate the interference graph by representing each of the data objects involved in the computational task as a node in the interference graph.

5. The system of claim 4, wherein the processor is configured to generate the interference graph by establishing an edge between a pair of nodes in the interference graph that represent two data objects involved in a common operation of the computational task.

6. The system of claim 5, wherein the processor is configured to generate the interference graph by assigning a weight to the edge, wherein the weight is a value representing a computational cost incurred by allocating the two data objects to a common bank in the memory.

7. The system of claim 6, wherein the processor is configured to compute the weight for the edge based on a relative size of a register of the processing-in-memory circuit to a size of a row in a bank of the memory.

8. The system of claim 6, wherein the processor is configured to compute the weight for the edge based on a size of the two data objects.

9. The system of claim 6, wherein the processor is configured to generate the interference graph by assigning one of the data objects involved in the computational task to one of the respective locations in the memory based on weights of one or more edges connected to a node representing the one of the data objects in the interference graph.

10. The system of claim 1, wherein the processor is configured to generate the interference graph with an objective of allocating data objects involved in a common operation for the computational task to different banks in the memory.

11. The system of claim 1, wherein the operation scheduler is configured to allocate the data objects to the respective locations in the memory and schedule the computational task for execution by the processing-in-memory circuit in response to identifying that the memory is available to allocate the data objects as indicated by the interference graph at runtime for the computational task.

12. A method comprising:
receiving an operation chain that includes a plurality of operations for execution by a processing-in-memory circuit;
generating an interference graph that assigns data objects involved in the operation chain to respective locations in a memory; and
allocating the data objects involved in the operation chain to the respective locations in the memory.

13. The method of claim 12, wherein generating the interference graph and allocating the data objects are performed prior to the processing-in-memory circuit executing the operation chain.

14. The method of claim 12, wherein generating the interference graph is performed automatically and independent of user input.

15. The method of claim 12, wherein generating the interference graph is performed based on a number of banks in a channel of the memory that is accessible by the processing-in-memory circuit.

16. The method of claim 12, wherein generating the interference graph comprises representing each of the data objects involved in the operation chain as a node in the interference graph.

17. The method of claim 16, wherein generating the interference graph comprises establishing an edge between a pair of nodes in the interference graph that represent two of the data objects involved in a common operation of the operation chain.

18. A method comprising:
receiving an interference graph for a computational task that assigns data objects involved in the computational task to respective locations in a memory;
identifying that one or more of the respective locations in the memory allocated by the interference graph are unavailable;
generating an adapted interference graph that assigns the data objects involved in the computational task to available locations in the memory, responsive to identifying that the one or more of the respective locations in the memory allocated by the interference graph are unavailable; and
allocating the memory for the computational task using the adapted interference graph.

19. The method of claim 18, wherein the interference graph is generated at compile time for the computational task and generating the adapted interference graph is performed at runtime for the computational task.

20. The method of claim 18, wherein the interference graph assigns the data objects involved in the computational task to the respective locations in the memory by associating each of the data objects with a color that represents a row in the memory and wherein generating the adapted interference graph comprises remapping at least one of the data objects to a different color that represents a different row in the memory.
